(19) United States
(12) Patent Application Publication
(10) Pub. No.: US 2019/0316699 A1
(43) Pub. Date: Oct. 17, 2019

(54) LOW-TORQUE VALVE

(71) Applicant: HAM-LET (ISRAEL - CANADA ) LTD., Nazareth Illit (IL)

(72) Inventors: Solieman KHOURY, Haifa (IL); Felix SHESTATSKI, Karmiel (IL); Sergey SERYOGIN, Migdal Ha-Emek (IL); Roni CHEKLER, Nazareth-Illit (IL)

(21) Appl. No.: 16/454,372

(22) Filed: Jun. 27, 2019

Related U.S. Application Data
(63) Continuation-in-part of application No. PCT/IL2017/051399, filed on Dec. 28, 2017.
(60) Provisional application No. 62/440,470, filed on Dec. 30, 2016.

(51) Int. Cl. F16K 25/00; F16K 5/04

(52) U.S. Cl. CPC F16K 25/005; F16K 5/0442

(57) ABSTRACT

A valve for controlling a fluid flow including (a) a valve body; (b) a valve stem securable within the valve body; the valve stem having a control portion configured for blocking the fluid flow and a tail portion configured to transfer a rotating torque; and (c) a deformable valve seat carried thereon in a coaxial and rotating manner; the valve stem and valve seat having inner and outer surfaces, respectively, conformal to each other. The outer surface of the valve stem has a circumferentially-arranged stepped area; the deformable valve seat when secured within the valve is deformed such that a space between the circumferentially-arranged stepped area of the outer surface and the inner surface of the valve seat is filled by the valve seat.

### RELATED APPLICATIONS

This application is a Continuation-in-Part of PCT Patent Application No. PCT/IL2017/051399 having International filing date of Dec. 28, 2017, which claims the benefit of priority of U.S. Provisional Application No. 62/440,470 filed on Dec. 30, 2016. The contents of the above applications are all incorporated by reference as if fully set forth herein in their entirety.

### FIELD OF THE INVENTION

The present invention relates to valves, and more particularly to low-torque valves.

### BACKGROUND OF THE INVENTION

A plurality of devices for controlling of fluid flow are known, such as valves and in particular ball-type valves, which are adapted to selectively open and close a fluid flow passage. It is particularly known that large-diameter ball-type valves are typically operated using high-torque.

U.S. Pat. No. 5,947,443 discloses a gas distribution valve including a body defining an inlet and an outlet passage, a central well containing a cylindrical plug disposed for arcuate displacement therein and including a transverse thru-bore that can be rotated into and out of axial alignment with the flow passages of said body for opening and closing the valve respectively. Overmolded elastomeric seat seals are provided for superior sealing that are urged against the well walls by an arcuate leaf spring intervening between the seals and the plug and extending in a direction concentric with the plug.

US20160208936 discloses a high-pressure trunnion ball valve having an upper stem and a lower stem having the same diameter are provided on an upper side and a lower side of the ball in an extending manner secured by slider bearings coated by a PTFC resin. There is a long-felt and unmet need for providing valves demonstrating reliable and no-leaks behavior by means of an integral valve seat embracing a flow regulation portion.

### SUMMARY OF THE INVENTION

The present invention seeks to provide an improved low-torque valve.

There is thus provided in accordance with an embodiment of the present invention a valve for controlling fluid flow passage, including a valve body; a valve stem securable within the valve body; the valve stem having a control portion configured for blocking the fluid flow and a tail portion configured to transfer a rotating torque; and a deformable valve seat carried thereon in a coaxial and rotating manner; said valve stem and valve seat having an inner and outer surfaces.

The outer surface of the valve stem has a circumferentially-arranged stepped area. The deformable valve seat when secured within the valve body is deformed such that a space between the circumferentially-arranged stepped area of the outer surface and the inner surface of said the seat is filled by deforming the latter.

Preferably, the outer surface of the valve stem is cylindrical and the inner surface of the valve seat is cylindrical.

Further preferably, contact surface between the valve stem and the valve seat is minimal in the direction in which forces are exerted on the valve stem along the longitudinal axis, thereby minimizing the torque created between the valve body and the handle.

Still preferably, the valve seat is formed by machining. Yet preferably, the valve seat is made of a polymeric material, selected from the group consisting of PEEK, PCTFE, PTFE, Reinforced PTFE, Modified PTFE and PFA.

Preferably, the outer surface of the valve stem defines a step surface operative to engage the valve seat and prevent disassembly of the valve stem and the valve seat. Further preferably, the outer surface of the valve stem defines a circumferential step recess, which is operative to enhance sealing between the valve stem and the valve body. Yet further preferably, the valve includes a disc adapted to be seated between the valve stem and the valve body and thereby preventing contact therebetween.

### BRIEF DESCRIPTION OF THE DRAWINGS

The present invention will be understood and appreciated more fully from the following detailed description, taken in conjunction with the drawings in which:

FIGS. 1A and 1B are respective simplified pictorial exploded illustration and sectional exploded illustration of a low-torque valve constructed and operative in accordance with an embodiment of the present invention, section being taken along lines B-B in FIG. 1A;

FIGS. 2A and 2B are respective simplified pictorial and sectional illustrations of a ring forming part of the low-torque valve of FIGS. 1A and 1B, section being taken along lines B-B in FIG. 2A;

FIGS. 3A and 3B are respective simplified pictorial and sectional illustrations of a valve seat forming part of the low-torque valve of FIGS. 1A and 1B, section being taken along lines B-B in FIG. 3A;

FIGS. 4A and 4B are respective simplified pictorial and sectional illustrations of a valve stem forming part of the low-torque valve of FIGS. 1A and 1B, section being taken along lines B-B in FIG. 4A;

FIGS. 5A and 5B are respective simplified pictorial and sectional illustrations of a disc forming part of the low-torque valve of FIGS. 1A and 1B, section being taken along lines B-B in FIG. 5A;

FIG. 6 is a simplified cut-out illustration of the assembled low-torque valve of FIGS. 1A and 1B; and

FIG. 7 is an enlarged cut-out illustration of the assembled low-torque valve of FIGS. 1A and 1B.

### DETAILED DESCRIPTION OF PREFERRED EMBODIMENTS

In accordance with an embodiment of the present invention, a valve is provided for controlling and adjusting passage of fluid within a flow system. Fluid is defined hereby as liquid, gas, vapor, gel or any other material or state thereof that can flow via one or more directing elements such as tubes, pipes, conduits and the like.

The flow system can be any system requiring control and adjustment of flow of fluids such as an engine gas transport system, a water piping system, flow—control components for the semiconductor industry, gas and oil (energy) industry, or any other system or industry that requires valve control for fluid flow control.

In accordance with some embodiments of the present invention, the valve is configured and located such as to control fluid flow between one or more outlets of at least one fluid directing means such as a tube, conduit, pipeline and the like into one or more inlets of at least one other directing means to one or more inlets of directing means. The valve can control a throughput of the fluid flow or prevent passage thereof by being located between a conduit outlet and another conduit inlet.

It is appreciated that usually all components of ball-type valves are made of stainless steel, other than the valve seat, which is made of a polymeric, relatively resilient material.

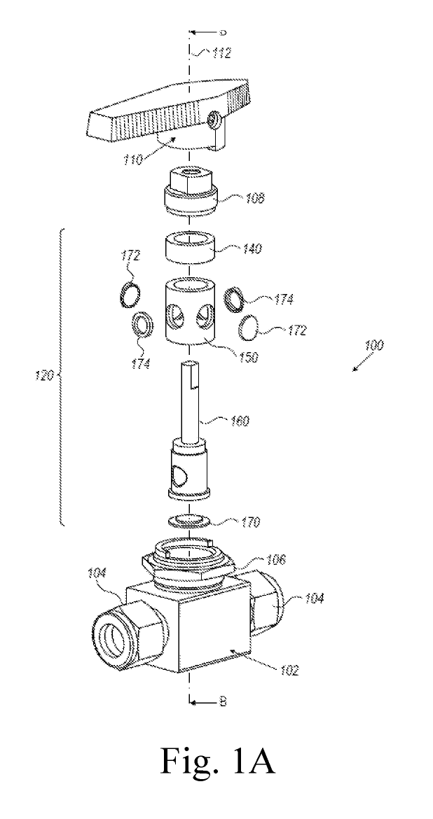

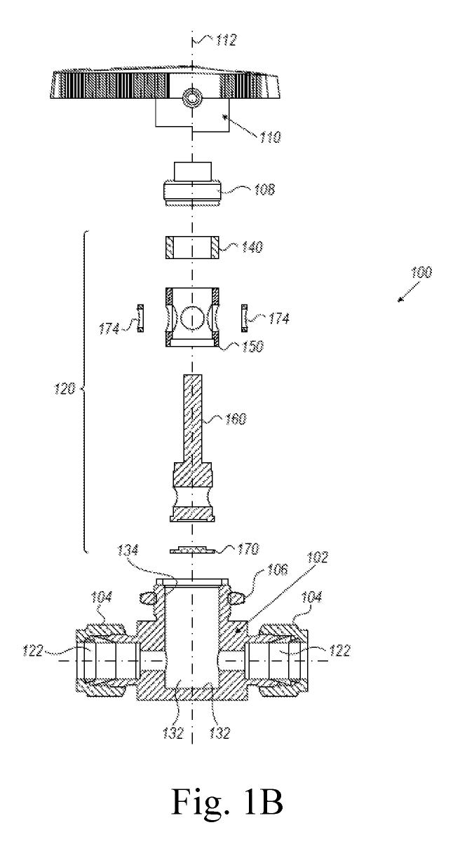

Reference is now made to FIGS. 1A and 1B, which are respective simplified pictorial exploded illustration and sectional exploded illustration of a low-torque valve constructed and operative in accordance with an embodiment of the present invention, section being taken along lines B-B in FIG. 1A.

A low-torque valve 100 is seen in FIGS. 1A and 1B, including a valve body 102 having a plurality of valve ports 104, generally extending in different radial directions and a connector portion 106 adapted for attachment with a nut 108. A handle 110 adapted to be selectably rotatably attached to the nut 108 and connector portion 106 of valve body 102.

It is noted that valve body 102 can have any number of valve ports 104.

A valve assembly 120 is arranged along a longitudinal axis 112 and is configured to be disposed between valve body 102 and handle 110.

It is seen in FIG. 1B that fluid flow passage is defined by bores 122 formed through ports 104 of the valve body 102. Bores 122 fluidly communicate with a valve assembly receiving cavity 130. Valve assembly receiving cavity 130 defines an upwardly facing surface 132 and a circumferential surface 134.

It is a particular feature of an embodiment of the present invention that as seen in FIGS. 1A and 1B, valve assembly 120 preferably includes a ring 140, adapted to be mounted onto a valve seat 150, which is adapted to be seated around a portion of a valve stem 160, which in turn is adapted to be seated onto a disc 170. It is additionally seen that typically two seat discs 172 and two seat rings 174 are adapted to be mounted onto valve seat 150 to prevent it from buckling when the valve seat 150 is assembled into the low-torque valve 100.

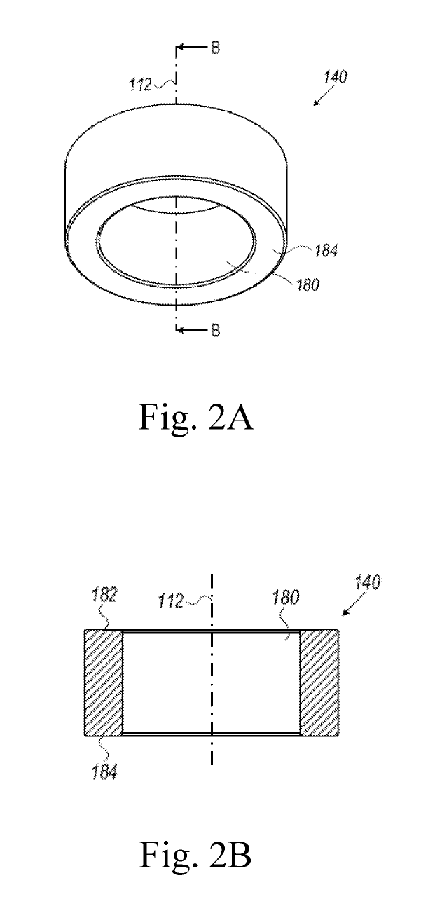

Reference is now made to FIGS. 2A and 2B, which are respective simplified pictorial and sectional illustrations of ring 140 forming part of the low-torque valve 100 of FIGS. 1A and 1B, section being taken along lines B-B in FIG. 2A.

Ring 140 is preferably an integrally formed element made of stainless steel and arranged along longitudinal axis 112. The ring 140 forms part of the valve assembly 120.

Ring 140 defines a through-going bore 180, an upwardly facing annular surface 182 and a downwardly facing annular surface 184.

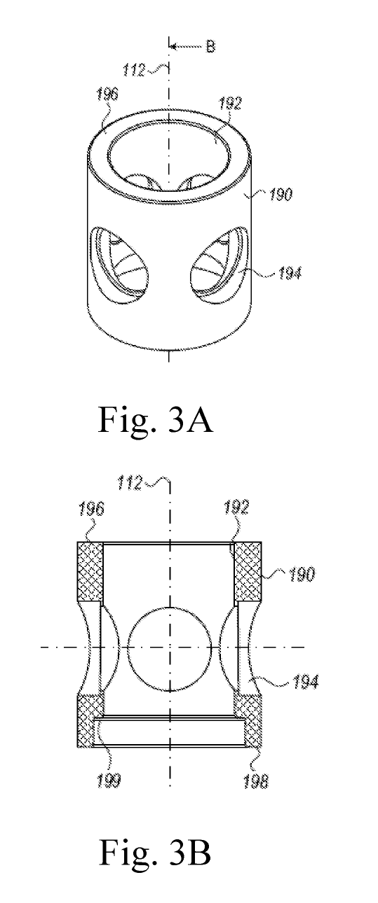

Reference is now made to FIGS. 3A and 3B, which are respective simplified pictorial and sectional illustrations of valve seat 150 forming part of the low-torque valve 100 of FIGS. 1A and 1B, section being taken along lines B-B in FIG. 3A.

Valve seat 150 is preferably an integrally formed element made of a polymeric material and arranged along longitudinal axis 112. The valve seat 150 forms part of the valve assembly 120.

It is a particular feature of an embodiment of the present invention that valve seat 150 is a hollow cylindrical element defining an outwardly facing cylindrical surface 190 and an inwardly facing cylindrical surface 192, adapted to fit to the cylindrical outer surface of valve stem 160.

It is noted that the inner surface of valve seat 150 can be of any non-spherical shape.

A plurality of bores 194 are formed in valve seat 150 and extend along axes which are perpendicular to longitudinal axis 112. It is appreciated that at least two of bores 194 are adapted to selectably communicate with bores 122 of valve body 102, when the low-torque valve 100 is disposed in an open operative orientation.

Valve seat 150 defines an upwardly facing surface 196 and a downwardly facing surface 198 and a circumferential downwardly facing step 199 formed adjacent the downwardly facing surface 198.

It is a particular feature of an embodiment of the present invention that the cylindrical valve seat 150 is formed by machining, thus allowing manufacturing of the valve seat 150 using the following materials: PEEK (polyetheretherketone); PCTFE (polychlorotrifluoroethylene); PTFE (polytetrafluoroethylene); RPTFE (Reinforced PTFE) in addition to TFM (modified PTFE) and PFA (Perfluoroalkoxy alkane), which are typically used while manufacturing valve seats by means of injection molding. It is noted that the valve seat 150 can additionally be manufactured using any other suitable polymeric material that provides the desired sealing characteristics between the valve stem 160 and the valve body 102.

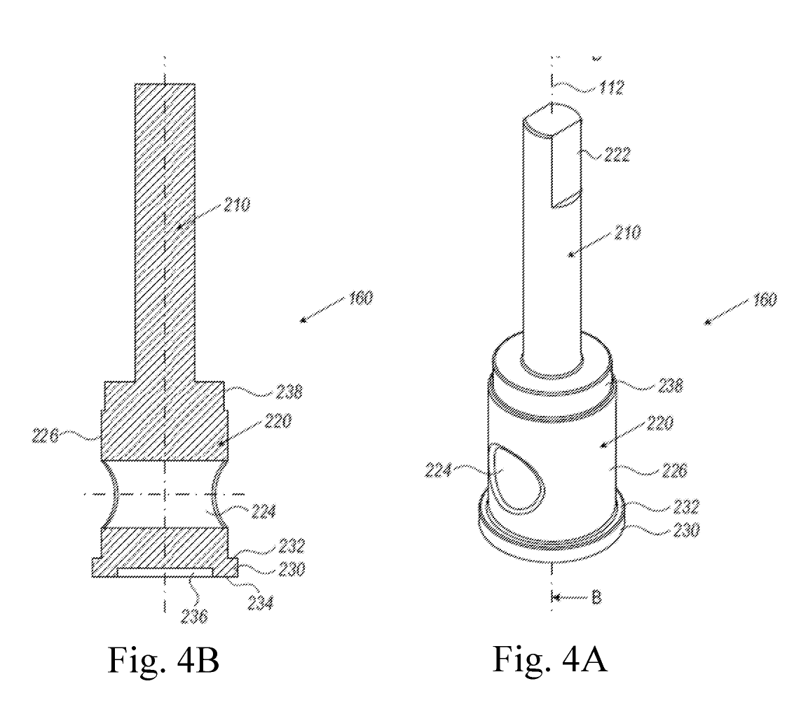

Reference is now made to FIGS. 4A and 4B, which are respective simplified pictorial and sectional illustrations of valve stem 160 forming part of the low-torque valve 100 of FIGS. 1A and 1B, section being taken along lines B-B in FIG. 4A.

Valve stem 160 is preferably an integrally formed element made of stainless steel and arranged along longitudinal axis 112. The valve stem 160 forms part of the valve assembly 120.

Valve stem 160 preferably includes an elongate connection portion 210 and a flow regulation portion 220.

Connection portion 210 has a non-rotational engagement surface 222, adapted for non-rotatably fixating the valve stem 160 relative to valve handle 110.

It is a particular feature of an embodiment of the present invention that flow regulation portion 220 of valve stem 160 has a cylindrical cross-section having a throughgoing bore 224 extending along an axis which is generally perpendicular to longitudinal axis 112. It is appreciated that bore 224 is adapted to selectably communicate with bores 122 of valve body 102, when the valve handle 110 is rotatebly suitably positioned, such as to position the low-torque valve 100 in an open operative orientation.

The flow regulation portion 220 of valve stem 160 defines an outwardly facing cylindrical surface 226. It is noted that alternatively, the flow regulation portion 220 of valve stem 160 can be of any other non-spherical shape.

A slightly outwardly extending circumferential flange 230 is formed at the bottom end of flow regulation portion 220 of valve stem 160. The flange 230 defines an upwardly facing step surface 232 and a downwardly facing surface 234. A recess 236 is formed in downwardly facing surface 234.

It is noted that a circumferential step recess 238 is formed at the top end of the flow regulation portion 220, which is operative for engaging the inner surface of ring 140, and thereby enhancing sealing between the valve stem 160 and the ring 140.

It is further noted that valve stem 160 may be integrally formed or alternatively, it may be formed of several separate parts coupled to each other.

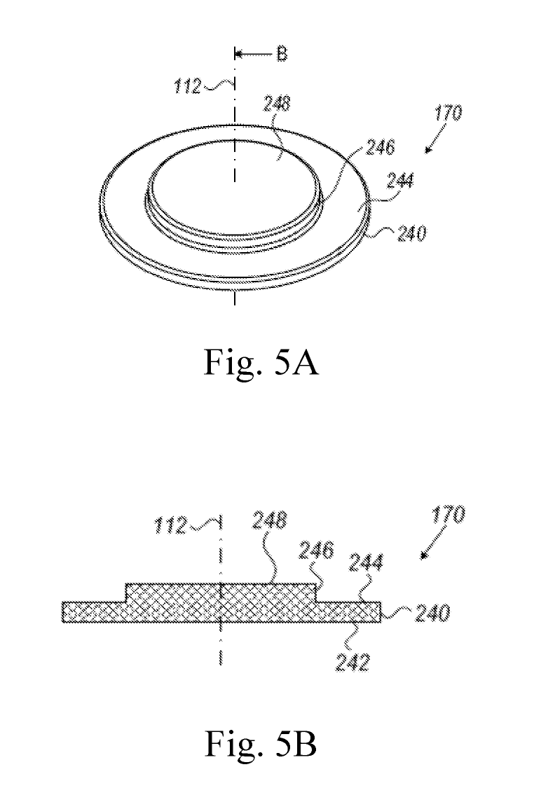

Reference is now made to FIGS. 5A and 5B, which are respective simplified pictorial and sectional illustrations of disc 170 forming part of the low-torque valve 100 of FIGS. 1A and 1B, section being taken along lines B-B in FIG. 5A.

Disc 170 is preferably an integrally formed element made of PCTFE and arranged along longitudinal axis 112. The disc 170 forms part of the valve assembly 120.

Disc 170 includes a circular portion 240 defining a downwardly facing surface 242 and an upwardly facing surface 244 and an upwardly extending circular protrusion 246 defining an upwardly facing surface 248. The protrusion 246 is adapted to be received within recess 236 of valve stem 160.

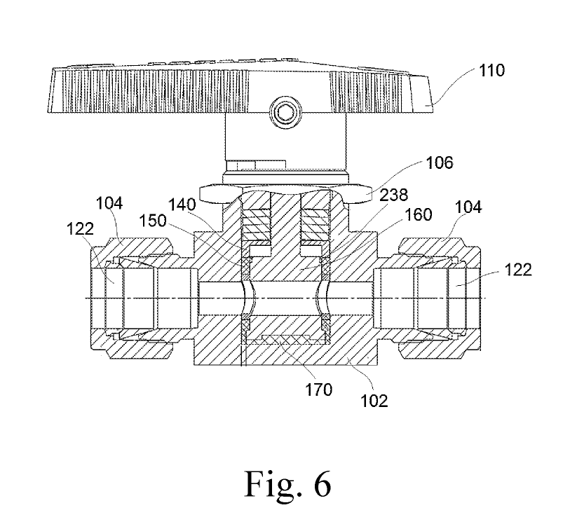

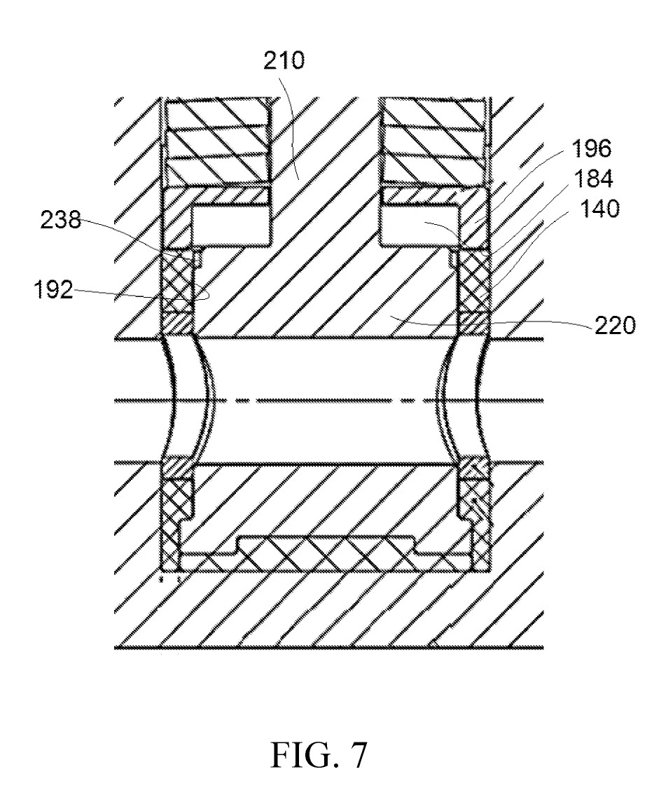

Reference is now made to FIGS. 6 and 7, which is a simplified cut-out illustration of the assembled low-torque valve 100 of FIGS. 1A and 1B.

It is further seen in FIG. 6 that the valve seat 150 is press-fit assembled between the valve stem 160 and the valve body 102. Valve stem 160 is retained between valve seat 150 and disc

It is appreciated that disc 170, which is made of a relatively resilient material, is operative to prevent contact between two metal parts, namely between the valve stem 160 and the valve body 102.

It is a particular feature of an embodiment of the present invention that when valve assembly 120 is inserted into valve body 102, and valve handle 110 is rotated relative to valve body 102, ring 140 exerts force on valve seat 150, such that valve seat 150 is deformed and pressurized between valve stem 160 and valve body 102 in order to create a seal therebetween.

It is appreciated that when the handle 110 and the valve stem 160 are rotatably suitably positioned with respect to valve body 102. It is seen in FIG. 6 that an interference-fit engagement is formed between the valve seat 150, valve body 102 and valve stem 160. It is particularly seen that outwardly facing cylindrical surface 226 of valve stem 160 engages inwardly facing cylindrical surface 192 of valve seat 150 and outwardly facing cylindrical surface 190 of valve seat 150 engages circumferential surface 134 of valve body 102.

The valve seat 150 is carried on the valve stem 160 in a coaxial and rotating manner. The outer surface 226 of said valve stem has a circumferentially-arranged stepped area 238. The deformable valve seat 150 when secured within the valve body 102 is deformed such that a space between the circumferentially-arranged stepped area 238 of the outer surface 226 and the inner surface of the valve seat 150 is filled by deforming the latter.

It is a particular feature of an embodiment of the present invention that minimal contact surface exists between valve seat 150 and valve stem 160 on which axial forces along longitudinal axis 112 are exerted, thus providing for low torque forces between valve stem 160 and valve seat 150 and thus in turn between handle 110 and valve body 102. It is particularly seen that upon rotation of handle 110, valve seat 150 is pressurized between ring 140 and valve stem 160 due to the following engagements: engagement between annular surface 184 of ring 140 and upwardly facing surface 196 of valve seat 150 and engagement of upwardly facing step surface 232 of valve stem 160 and downwardly facing step 199 of valve seat 150.

It is a particular feature of an embodiment of the present invention that due to the fact that both the flow regulation portion 220 of valve stem 160 and valve seat 150 are of a cylindrical cross-section, the engagement surface between the valve stem 160 and the valve seat 150 on which forces are exerted in the direction of longitudinal axis is minimal, thus torque forces therebetween are minimized.

It is a further particular feature of an embodiment of the present invention that due to the fact that the valve seat 150 is machined and both valve seat 150 and valve stem 160 have cylindrical cross-section, these two components can be easily separated at any given time.

It is a yet further particular feature of an embodiment of the present invention that the operating torque of the low-torque valve 100, required for selectably positioning the valve 100 in the open operative orientation or the closed operative orientation, is at least 40% lower than the operating torque of typical commercially available ball valves having the same valve seat outer diameter and valve seat material as the low-torque valve 100 constructed in accordance with an embodiment of the present invention.

It is additionally noted that valve assembly 120 is replaceable following a pre-determined amount of operation cycles of low-torque valve 100.

It will be appreciated by persons skilled in the art that the present invention is not limited by what has been particularly shown and described hereinabove. Rather the scope of the present invention includes both combinations and subcombinations of various features described hereinabove as well as variations and modifications thereof which are not in the prior art.

1. A valve for controlling a fluid flow, comprising:
a. a valve body;
b. a valve stem securable within said valve body; said valve stem having a control portion configured for blocking said fluid flow and a tail portion configured to transfer a rotating torque;
c. a deformable valve seat carried thereon in a coaxial and rotating manner; said valve stem and valve seat having inner and outer surfaces, respectively, conformal to each other;
wherein said outer surface of said valve stem has a circumferentially-arranged stepped area; said deformable valve seat when secured within said valve is deformed such that a space between said circumferentially-arranged stepped area of said outer surface and said inner surface of said valve seat is filled by said valve seat.

2. The valve according to claim 1, wherein said outer surface of said valve stem is cylindrical and said inner surface of said valve seat is cylindrical.

3. The valve according to claim 1, wherein contact surface between said valve stem and said valve seat is minimal in the direction in which forces are exerted on said valve stem along said longitudinal axis, thereby minimizing torque forces created between said valve body and said handle.

4. The valve according to claim 1, wherein said valve seat is formed by machining.

5. The valve according to claim 4, wherein said valve seat is made of a polymeric material, selected from the group consisting of PEEK, PCTFE, PTFE, Reinforced PTFE, Modified PTFE and PFA.

6. The valve according to claim 1 comprising a disc adapted to be seated between said valve stem and said valve body and thereby preventing contact therebetween.
